(19) United States
(12) Patent Application Publication
(10) Pub. No.: US 2003/0050122 A1
(43) Pub. Date: Mar. 13, 2003

(54) Flexible coupling with eccentric locking system

(76) Inventors: Don Yorston, Verndale, WA (US); Mark Flaherty, Prince George (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/953,673

(22) Filed: Sep. 12, 2001

(51) Int. Cl. F16D 3/64; F16D 3/78

(52) U.S. Cl. 464/73

(57) ABSTRACT

A flexible coupling system to connect two substantially axially aligned shafts, comprises coupling members mountable on the ends of each of the shafts with each coupling member having a drive face for engagement with the opposed drive face of the other coupling member to provide a torque transmitting connection. Each coupling member has a tubular extension extending away from the drive face with an inner axial surface engageable over the shaft and a distal end. A locking ring engageable with the distal end of each coupling member is provided. Each distal end and each locking ring are formed with one of an axially extending annular eccentric projection and an axially extending eccentric shoulder. The shoulder and projection are rotatable to interengage and lock with each other in an interference fit to lock the coupling members on the shaft.

### FIELD OF INVENTION

This invention relates to flexible coupling device for connecting two substantially axially aligned shafts.

### BACKGROUND OF THE INVENTION

Flexible coupling devices to connect together a drive shaft and a driven shaft are well known. Generally, the coupling devices comprise a pair of coupling members mounted to the ends of the shafts to be connected by a mounting system. The coupling members are formed with mating surfaces to engage with mating surfaces on the opposed coupling member that interlock to transmit the torque of the drive shaft to the driven shaft. Often the mating surfaces comprise a plurality of teeth that project toward each other from adjacent ends of the shafts. To ensure that the couplings are flexible, the designs generally include a flexible element that is engaged between the mating surfaces or teeth of the coupling members to accommodate some mis-alignment and vibration of the two shafts.

Examples of prior art coupling devices are found in the following patents:

U.S. Pat. No. 1,865,950 to Petskeyes;

U.S. Pat. No. 2,007,513 to Westburgh;

U.S. Pat. No. 2,892,327 to Kressin;

U.S. Pat. No. 2,896,430 to Olson;

U.S. Pat. No. 3,884,049 to Pauli;

U.S. Pat. No. 4,792,320 to Nickel;

U.S. Pat. No. 4,932,924 to Löbel; and

Canadian Patent 1,325,728 to Hoyt et al.

An important feature of any coupling member is that it be reliably mounted to its shaft so that operation of the coupling device is trouble free over long periods. Various mounting systems for coupling members are known. It is common to use set screw arrangements or bushing members in combination with a shaft key to lock the coupling members to their shafts to prevent both axial and rotary motion of the coupling member with respect to the shaft.

Vibration and opposing axial forces of the connected shafts tend to eventually loosen set screws. When the coupling members become loose and move out of proper operating position, heat and friction result with consequent failure of the connection.

Bushing arrangements generally employ a separate bushing sleeve formed with a constant bore and an outer surface that tapers toward the end of the shaft. The coupling member comprises a mating face with a correspondingly tapered cylindrical bore to receive the tapered bushing sleeve. The bushing sleeve is fitted onto the shaft and then the coupling member is installed. Fasteners are used to pull the tapered bushing sleeve into the coupling member to wedge the coupling member onto the shaft. The disadvantage of this arrangement is that the bushing element and the coupling member together tend to occupy a significant length of the shaft and therefore such a mounting system is possible only when a required minimum length of shaft is exposed. In many products and installations, the coupling devices must be situated on a short length of exposed shaft in an area having limited access which makes installation of the bushing and coupling members difficult if not impossible. Furthermore, use of a bushing arrangement tends to reduce the amount of torque that the coupling can handle by as much as 50%. It is also desirable that the coupling members are light weight and durable. To address the issue of weight, the coupling members are preferably formed from aluminum, however, aluminum is a relatively soft metal that does not lend itself to reliable mounting to a shaft when a key way or set screw arrangement is the sole locking system. The soft aluminum is prone to wear and enlargement at the key passage or screw opening which can result in movement or slippage of the coupling members.

### SUMMARY OF THE INVENTION

To address the foregoing problems, the present invention provides a lightweight, reliable flexible coupling system that uses an eccentric locking system to securely and reliably lock each coupling member to its shaft. Preferably, the eccentric locking system is used in conjunction with a conventional key way and/or set screw locking scheme.

Accordingly, the present invention provides a flexible coupling system to connect two substantially axially aligned shafts, comprising:

coupling members mountable on the ends of each of the shafts having opposed proximal ends adapted to drivingly engage with each other and distal ends formed with an eccentric surface; and

locking devices engageable with each of the distal ends of the respective coupling members wherein each of the locking devices is formed with a corresponding eccentric surface to create an interference locking fit with the eccentric surface of the distal end of the coupling members to lock the coupling members to the shafts.

The present invention also provides a flexible coupling system to connect two substantially axially aligned shafts, comprising:

coupling members mountable on the ends of each of the shafts, each coupling member having a drive face for engagement with the opposed drive face of the other coupling member to provide a torque transmitting connection;

each coupling member having a tubular extension extending away from the drive face with an inner axial surface engageable over the shaft and a distal end; and

a locking ring engageable with the distal end of each coupling member, each distal end and each locking ring being formed with one of an axially extending annular eccentric projection and an axially extending eccentric shoulder, the shoulder and projection being rotatable to interengage and lock with each other in an interference fit to lock the coupling members on the shaft.

In a further aspect, the present invention provides a flexible coupling system to connect two substantially axially aligned shafts, comprising:

coupling members mountable on the ends of each of the shafts, wherein the distal portions of the coupling members are eccentrically machined;

a removable flexible insert member engageable with the proximal ends of each of said coupling members; and

locking devices engageable with each of the distal ends of the respective coupling members wherein the locking devices are eccentrically counter-bored to create an interference locking fit with the eccentrically machined distal portions to lock the coupling members to the shafts.

The flexible coupling system of the present invention provides a compact coupling unit that is installable for operation in an environment where only a short length of exposed shaft in available for mounting each coupling member. The coupling system anchors the coupling members securely to their shafts to maximize the load torque that the coupling system can withstand. When used in conjunction with a conventional key locking system, the eccentric locking arrangement of the present invention holds the coupling members tight to the shaft enabling the key to transmit the torque through the through the coupling without danger of any rocking motion that will tend to fret the keyway.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

Aspects of the present invention are illustrated, merely by way of example, in the accompanying drawings in which:

FIG. 1 is an exploded view of the flexible coupling system according to a preferred embodiment of the present invention;

FIG. 2 is cross-sectional view through the coupling members when in their assembled positions on the shafts;

FIG. 3 is an end view of the locking ring showing the eccentric shoulder; and

FIG. 4 is an end view of the coupling member showing the eccentric annular flange.

### DESCRIPTION OF THE PREFERRED EMBODIMENTS

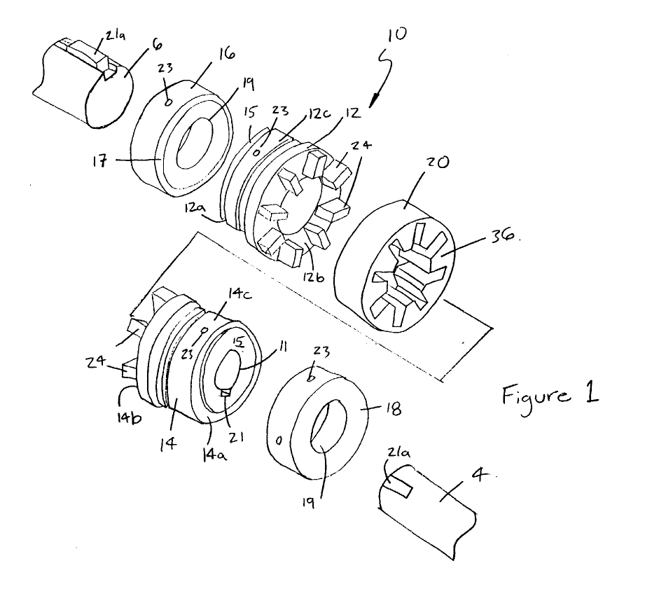

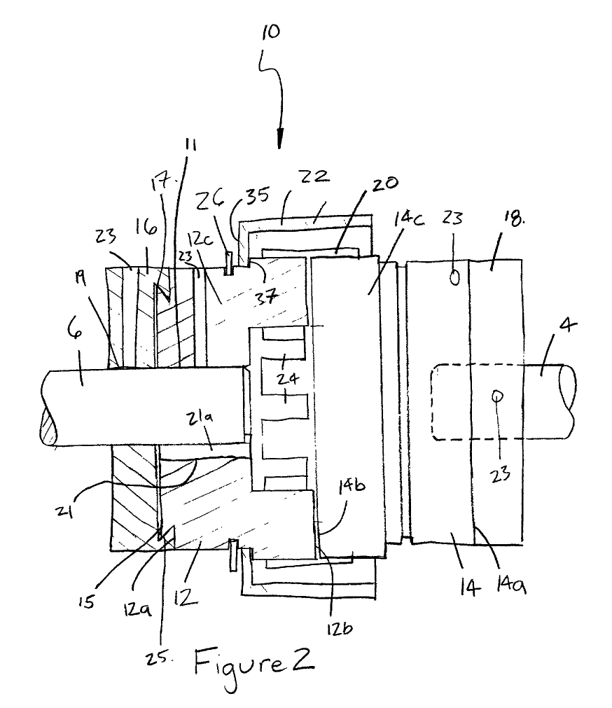

Referring to FIGS. 1 and 2 there is shown a flexible coupling 10 with an eccentric locking system according to a preferred embodiment of the present invention. The flexible coupling 10 includes two generally cylindrical coupling members 12 and 14 to join two substantially axially aligned shafts 4 and 6 by mounting of the coupling members in opposed relationship on the ends of the shafts. As best shown in FIG. 2, each coupling member has a proximal drive face 12b and 14b, respectively, for engagement with the opposed drive face of the other coupling member to provide a torque transmitting connection. Tubular extensions 12c, 14c extend away from the drive faces to define the body of the coupling members. Each body is formed with a central axially extending passage 11 dimensioned to slidably receive one of the shafts 4, 6 to be joined.

Separate locking rings 16 and 18 are engageable with the distal ends or faces 12a, 14a of the coupling members to secure the coupling members to the shaft. The locking rings 16 and 18 and the distal ends 12a, 14a of the coupling members are formed with an eccentric locking system to accomplish the locking function. Each distal end face 12a, 14a and each locking ring is formed with either an axially extending eccentric annular projection or an axially extending eccentric shoulder. In the illustrated embodiment, distal end faces 12a, 14a are formed with an eccentric annular projection 15 and locking rings 16, 18 are formed with a corresponding eccentric annular shoulder 17, however, it will be obvious to a person skilled in the art that this arrangement can be switched.

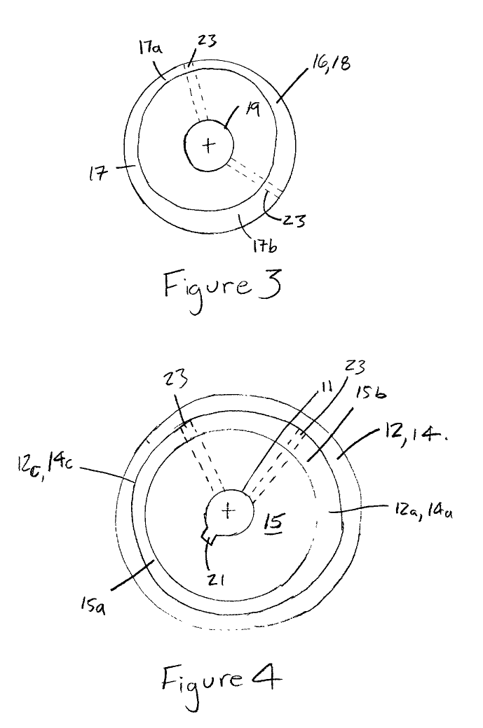

FIG. 3 is an end view of locking ring 16 or 18. Each locking ring comprises a disc shaped body having a central opening 19 to accommodate the shaft and a peripheral shoulder 17 that is eccentric or non-centred with respect to the longitudinal axis extending through opening 19. Note that shoulder 17 is thinner at location 17a than at 17b. Shoulder 17 extends axially parallel to the longitudinal axis. Opening 19 is intersected by set screw passages 23 to receive fasteners to secure the locking ring to the shaft. Openings 19 of the locking rings are alignable with openings 11 in the coupling members to define a continuous passage to receive the shafts to be joined.

FIG. 4 is an end view of coupling member 12 or 14. Central opening 11 defines a longitudinal axis. Distal end 12a, 14a, which is co-axial with the axis of opening 11, is formed with an annular eccentric projection or flange 15, that is off centre with respect to opening 11. Note that flange 15 is closer to the side wall of tubular extension 12c, 14c at point 15a than at 15b. As with the locking ring, each coupling member is formed with set screw passages 23 to assist in securing the coupling member to the shaft. Each coupling member also includes a keyway 21 formed in central opening 11 to receive a key 21a that extends in a corresponding keyway in the shaft (FIG. 2). Keyways 21 only extend within the coupling members. It is necessary for the locking rings to be rotatable on the shafts to create the interference fit with the coupling members.

Preferably, flange 15 is machined on the distal faces of the coupling member. Shoulder 17 is counter-bored on the face of locking ring 17.

As best shown in FIG. 2, shoulder 17 and flange 15 are preferably formed with complementary angled sides 25 to assist in interlocking of the surfaces. Eccentric shoulder 17 and eccentric flange 15 are dimensioned to inter-engage and bind with each other in an interference fit when one is rotated with respect to the other to wedge each coupling member securely against the shaft.

At the proximal ends or drive faces 12b, 14b of the coupling members, the coupling system 10 of the present invention relies on a removable flexible insert member 20 of elastomeric material to interconnect the drive faces. Flexible insert member 20 is preferably constructed of Polyether urethane of a pre-selected stiffness depending on the application of coupling members 12 and 14. The drive faces 12b and 14b are each formed with spaced, axially extending teeth 24 that engage flexible member 20. Each tooth 24 extends radially across annular face 12b, 14b from an inner tooth edge 30 adjacent central opening 11 to an outer tooth edge 34 at the periphery of the drive face. Flexible insert member 20 is provided with internal ribs 36 that are insertable into the spaces between the two sets of teeth 24 of the opposed drive faces. Flexible insert member 20 acts to directly connect the teeth of the two coupling units to transmit torque between the units while absorbing vibration and accommodating limited misalignment of the two connected shafts.

As best shown in FIG. 2, the drive faces of coupling members 12 and 14 and flexible insert member 20 are preferably housed and sealed within outer casing 22 which is slidable over the assembled joint. Outer casing 22 acts to protect flexible insert member 20 from the environment.

Outer casing 22 is formed with a radially extending shoulder 35 to engage against a corresponding shoulder 37 formed on coupling members 12 and 14 after sliding the casing over the assembled joint. Outer casing 22 can be installed on either side of coupling members 12 and 14 and is preferably secured in place with a snap ring 26.

It will be appreciated by those skilled in the art that drive faces 12b, 14b of coupling member 12 and 14 can be formed with a variety of mating surfaces that permit driving connection to a corresponding mating surface of an opposed coupling member on an adjacent substantially axially aligned shaft. The use of teeth 24 and flexible insert member 20 is described simply by way of example. Members that rely on torus, grid or disk style couplings are only some of the possible interlocking schemes that can be used with the coupling system of the present invention.

Operation

To couple first and second substantially axially aligned shafts together, a user initially slides snap ring 26, casing 22 and finally a locking ring over the first shaft via the space between the shafts to a temporary parking position spaced from the end of the shaft. Key 21a is then inserted into the keyway 21 on the first shaft. A coupling member is slid over the end of the first shaft, distal end first, and set screws are tightened into place radially through the coupling member to locate the coupling member on the first shaft. The locking ring parked on the first shaft is then slid into engagement with the distal end of the coupling member. The user rotates the locking ring on the shaft until hand tight to create an initial interference fit between the eccentric flange on the distal end of the coupling member and the eccentric shoulder formed in the locking ring. Then using a drift pin and hammer, the locking ring is tapped to wedge the eccentric flange and shoulder together to lock the coupling member onto the shaft. The user then applies set screws through the holes in the locking ring to prevent rotation.

The second locking ring is then slid over the end of the second shaft via the space between the shaft ends to a temporary parking location along the shaft and a key is inserted into the keyway. The second coupling member is then slid over the end of the second shaft to engage with the key. Set screws are tightened to locate the second coupling member on the second shaft. The second locking ring is then moved from its temporary parking location into engagement with the second coupling member and rotated to lock the eccentric surfaces on the locking ring and the coupling member. Set screws are tightened through the second locking member to prevent rotation. The first and second shafts are then moved axially to bring the drive faces of the coupling member into mating engagement for transmitting torque. The user then slides outer casing 22 into place over the engaged drive faces and secures the casing in place with, for example, snap ring 26.

Removal of the coupling involves reversing the above procedure. The eccentric locking arrangement of the present invention provides an additional locking system to minimize movement of the coupling members on the shaft. This avoids any rocking motion of the coupling members which tends to fret the keyway.

Although the present invention has been described in some detail by way of example for purposes of clarity and understanding, it will be apparent that certain changes and modifications may be practised within the scope of the appended claims.

We claim:

1. A flexible coupling system to connect two substantially axially aligned shafts, comprising:
coupling members mountable on the ends of each of the shafts, wherein the distal portions of the coupling members are eccentrically machined;
a removable flexible insert member engageable with the proximal ends of each of said coupling members; and
locking devices engageable with each of the distal ends of the respective coupling members wherein the locking devices are eccentrically counter-bored to create an interference locking fit with the eccentrically machined distal portions to lock the coupling members to the shafts.

2. The flexible coupling system of claim 1 wherein each of said locking devices is a ring member.

3. The flexible coupling system of claim 1 wherein each of said coupling members includes means to engage said flexible member.

4. The flexible coupling system of claim 3 wherein said means to engage said flexible member comprises a plurality of axially extending flanges that interfit with the flexible member.

5. The flexible coupling system of claim 1 further comprising an outer casing to house the coupling members and flexible member.

6. The flexible coupling system of claim 5 wherein the outer casing further comprises an inner shoulder to abut and engage one of the coupling members.

7. The flexible coupling system of claim 6 further comprising means to secure the outer casing to the coupling members.

8. The flexible coupling system of claim 7 wherein the means to secure the outer casing to the coupling members is a snap ring.

9. A flexible coupling system to connect two substantially axially aligned shafts, comprising:
coupling members mountable on the ends of each of the shafts, each coupling member having a drive face for engagement with the opposed drive face of the other coupling member to provide a torque transmitting connection;
each coupling member having a tubular extension extending away from the drive face with an inner axial surface engageable over the shaft and a distal end; and
a locking ring engageable with the distal end of each coupling member, each distal end and each locking ring being formed with one of an axially extending annular eccentric projection and an axially extending eccentric shoulder, the shoulder and projection being rotatable to interengage and lock with each other in an interference fit to lock the coupling members on the shaft.

10. A flexible coupling device as claimed in claim 9 in which the locking rings and coupling members are formed with key passages to engage a key on the shafts.

11. A flexible coupling device as claimed in claim 9 in which the locking rings and coupling members are formed with

12. A flexible coupling device as claimed in claim 9 including a plurality of spaced, projecting portions formed on the opposed drive faces of each coupling member extending toward one another; and
an annular elastomeric member having internal ribs that are insertable into the spaces between the projecting portions of the opposed drive faces to transmit torque between the drive faces.

13. A flexible coupling device as claimed in claim 12 in which each coupling member is a generally cylindrical body having a circular drive face and a central bore therethrough that is co-axial with the tubular extension to define an annular surface from which the projecting portions extend, each projecting portion extending radially across the annular surface from an inner edge at the central bore to an outer edge at the periphery of the cylindrical body.

14. A flexible coupling device as claimed in claim 9 in which the coupling members include key ways to receive a key mounted on the shaft.

15. A flexible coupling device as claimed in claim 9 in which the coupling members and the ring members are formed with passages to receive set screws to further anchor the members to the shaft.

16. A flexible coupling system to connect two substantially axially aligned shafts, comprising:
coupling members mountable on the ends of each of the shafts having opposed proximal ends adapted to drivingly engage with each other and distal ends formed with an eccentric surface; and
locking devices engageable with each of the distal ends of the respective coupling members wherein each of the locking devices is formed with a corresponding eccentric surface to create an interference locking fit with the eccentric surface of the distal end of the coupling members to lock the coupling members to the shafts.

17. The flexible coupling system of claim 16 wherein each of said locking devices is a ring member.

18. The flexible coupling system of claim 17 wherein each ring member includes at least one passage to received set screws to further anchor the ring member to the shaft.

19. The flexible coupling system of claim 16 wherein each coupling member includes at least one passage to received set screws to further anchor the coupling member to the shaft.
